(19) United States
(12) Patent Application Publication
(10) Pub. No.: US 2024/0001517 A1
(43) Pub. Date: Jan. 4, 2024

(54) SYNCHRONOUSLY LINKABLE HAND TOOL

(71) Applicant: NEXCOM INTERNATIONAL CO., LTD., New Taipei City (TW)

(72) Inventor: Yi-Ching CHOU, New Taipei City (TW)

(21) Appl. No.: 17/857,120

(22) Filed: Jul. 4, 2022

(51) Int. Cl. B25B 17/00; B25B 15/00; B25B 23/00

(52) U.S. Cl. CPC B25B 17/00; B25B 15/008; B25B 23/0042

(57) ABSTRACT

A synchronously linkable hand tool includes a base, a rotation mechanism, a first driven mechanism and a second driven mechanism. The rotation mechanism is rotatably connected to the base and includes a driving gear. The first driven mechanism is disposed on the base and includes a first driven gear and a first locking/unlocking member connected to and rotated by the first driven gear. The second driven mechanism is disposed on the base and includes a second driven gear and a second locking/unlocking member connected to and rotated by the second driven gear. The first driven gear and the second driven gear are rotated by the driving gear to synchronously rotate the first locking/unlocking member and the second locking/unlocking member. Therefore, the force is uniform during locking or unlocking to avoid damage to the workpiece.

### BACKGROUND

### Technical Field

The disclosure relates to a hand tool, particularly to a synchronously linkable hand tool.

### Description of Related Art

The way to combine two different objects is mostly realized by the cooperation of screws and hand tools. Therefore, hand tools are closely related to us in life and work. Based on this, the inventor has improved related-art hand tools.

Most of the related-art hand tools for locking or unlocking are operated in a single-point-to-single-point manner. For the applications where many places need to be locked or unlocked at the same time, the force cannot be evenly applied, which may cause damage to the workpiece.

In view of this, the inventors have devoted themselves to the above-mentioned related art, researched intensively and cooperated with the application of science to try to solve the above-mentioned problems. Finally, the invention which is reasonable and effective to overcome the above drawbacks is provided.

### SUMMARY

An object of the disclosure is to provide a synchronously linkable hand tool, which utilizes the first and second driven mechanisms to make the force uniform during locking or unlocking to avoid damage to the workpiece.

To accomplish the above object, the disclosure provides a synchronously linkable hand tool, which includes a base, a rotation mechanism, a first driven mechanism and a second driven mechanism. The rotation mechanism is rotatably connected to the base and includes a driving gear. The first driven mechanism is disposed on the base and includes a first driven gear and a first locking/unlocking member connected to and rotated by the first driven gear. The second driven mechanism is disposed on the base and includes a second driven gear and a second locking/unlocking member connected to and rotated by the second driven gear. The first driven gear and the second driven gear are rotated by the driving gear to synchronously rotate the first locking/unlocking member and the second locking/unlocking member.

The disclosure further has the following functions. The operating time may be shortened and the labor costs may be effectively saved.

### BRIEF DESCRIPTION OF THE DRAWINGS

FIG. 1 is a perspective view of the synchronously linkable hand tool of the disclosure;

FIG. 2 is another perspective view of the synchronously linkable hand tool of the disclosure;

FIG. 3 is an assembled cross-sectional view of the synchronously linkable hand tool of the disclosure;

FIG. 4 is a cross-sectional view of the synchronously linkable hand tool of the disclosure along another direction; and

FIG. 5 is a cross-sectional view of the using status of the disclosure applied to a workpiece.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

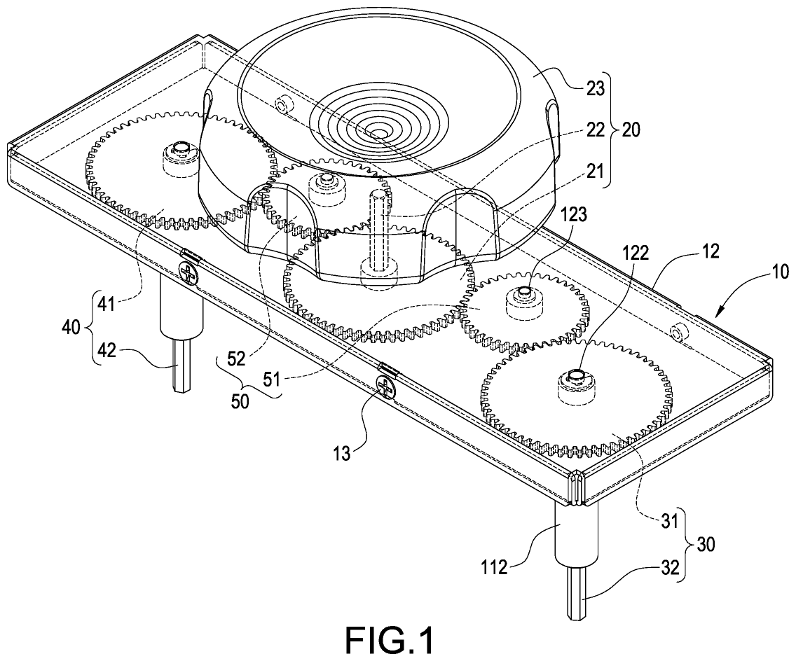

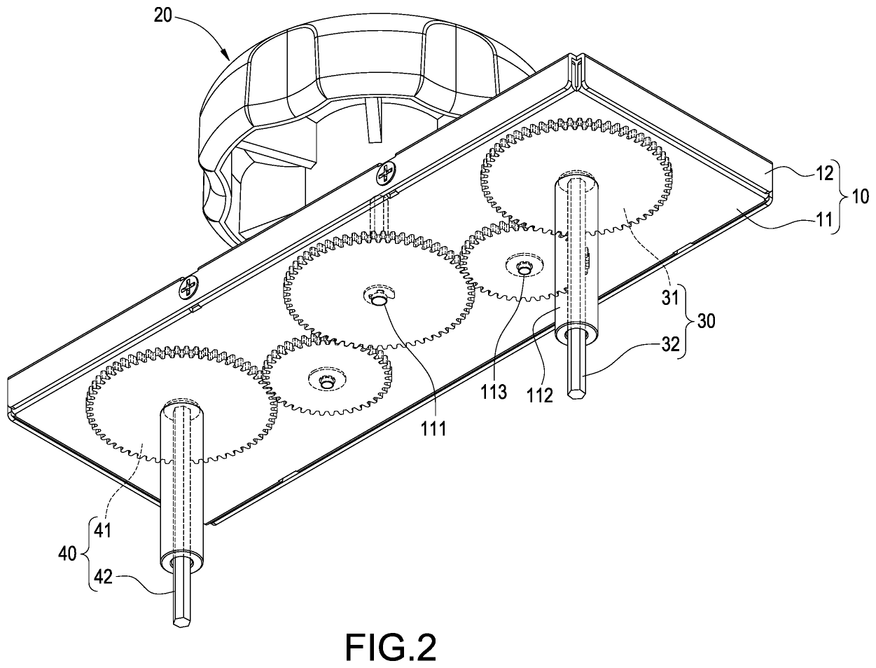

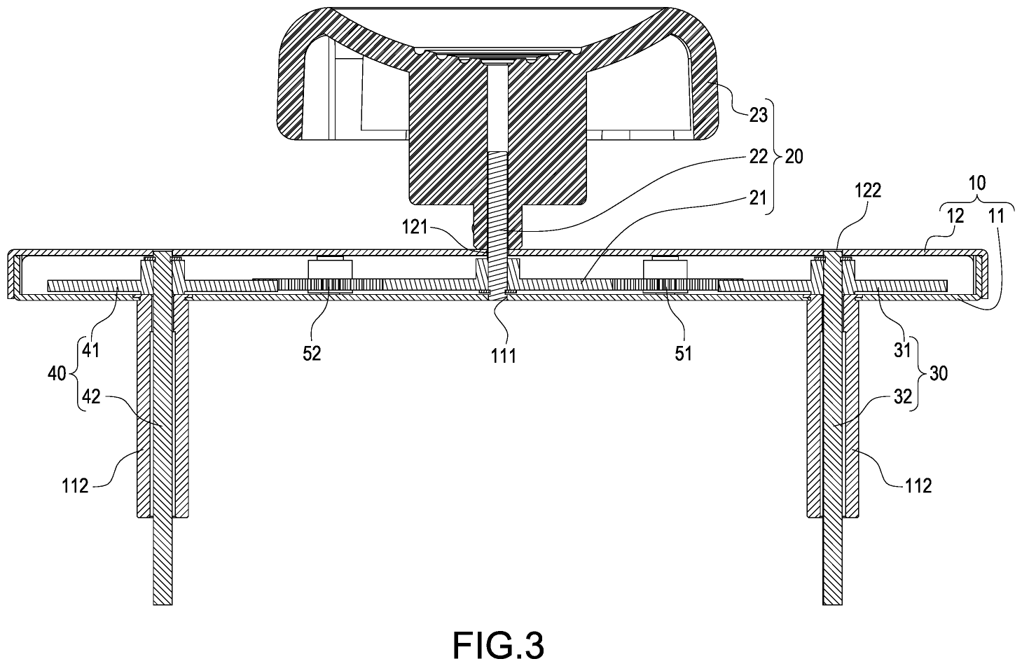

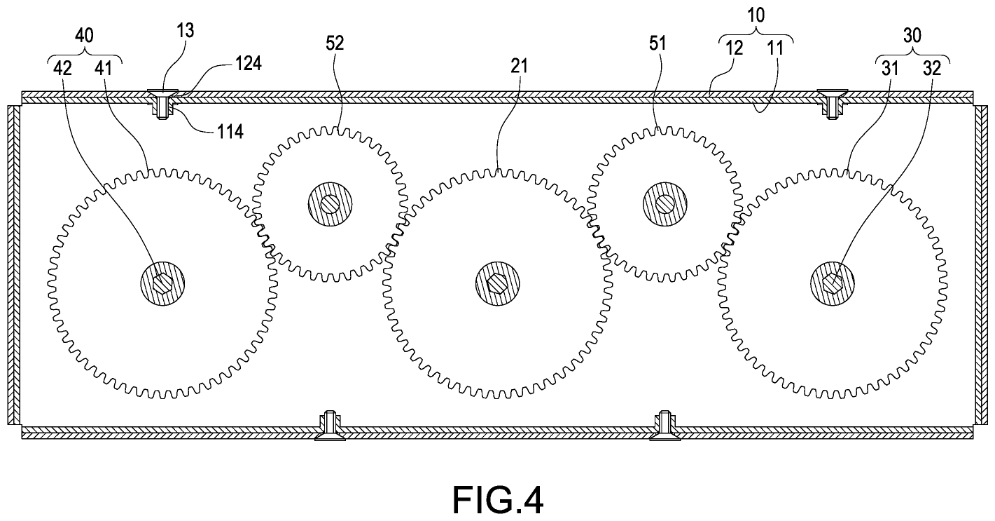

Please refer to FIGS. 1-4. The disclosure provides a synchronously linkable hand tool, which includes a base 10, a rotation mechanism 20, a first driven mechanism 30 and a second driven mechanism 40.

The base 10 includes a lower casing 11 and an upper casing 12. The middle of the lower casing 11 is formed with a pivot hole 111. Each of two sides of the lower casing 11 is connected with a hollow guide rod 112. An end of each hollow guide rod 112 is fixed onto the lower casing 11. Also, a lower rod connecting hole 113 is separately formed between the pivot hole 111 of the lower casing 11 and each hollow guide rod 112. Further, the sidewall of the lower casing 11 is disposed with multiple threaded rods 114.

The upper casing 12 correspondingly covers the lower casing 11. The middle of the upper casing 11 is formed with a through hole 121 corresponding to the pivot hole 111 in position. Each of two sides of the upper casing 12 is formed with an upper shaft connecting hole 122. Each upper shaft connecting hole 122 is arranged corresponding to each hollow guide rod 112. Also, an upper rod connecting hole 123 is separately formed between the through hole 121 and each upper shaft connecting hole 122 of the upper casing 12. Each upper rod connecting hole 123 is arranged corresponding to each lower rod connecting hole 113. Further, the sidewall of the upper casing 12 is formed with multiple via holes 124. Each via hole 124 is arranged corresponding to each threaded rod 114 to allow a fastener 13 to pass the via hole 124 to lock to the threaded rod 114.

The rotation mechanism 20 is rotatably connected to the middle of the base 10 and includes a driving gear 21, a shaft 22 and a knob 23. The shaft 22 passes through and is fixedly connected with the driving gear 21. An end of the shaft 22 is pivotally connected to the pivot hole 111, and the other end of the shaft 22 passes through and projects from the upper casing 12 to be fixed to the knob 23. In the embodiment, the driving gear 21 is a spur gear.

The first driven mechanism 30 is disposed on the base 10 and located on a side of the rotation mechanism 20 and includes a first driven gear 31 and a first locking/unlocking member 32. In the embodiment, the first driven gear 31 is a spur gear which may be engaged with the driving gear 21. The first locking/unlocking member 32 may be a flathead screwdriver, a Phillips screwdriver, or a polygonal screwdriver. The first locking/unlocking member 32 passes and is fixed to the first driven gear 31 to make the first locking/unlocking member 32 rotate with the first driven gear 31. An end of the first locking/unlocking member 32 is pivotally connected to the upper shaft connecting hole 122, and the other end of the first locking/unlocking member 32 passes through and projects from the hollow guide rod 112.

The second driven mechanism 40 is disposed on the base 10 and located on another side of the rotation mechanism 20, and includes a second driven gear 41 and a second locking/unlocking member 42. In the embodiment, the second driven gear 41 is a spur gear which may be engaged with the driving gear 21. The second locking/unlocking member 42 may also be a flathead screwdriver, a Phillips screwdriver, or a polygonal screwdriver. The second locking/unlocking member 42 passes and is fixed to the second driven gear 41 to make the second locking/unlocking member 42 rotate with the second driven gear 41. An end of the second locking/unlocking member 42 is pivotally connected to another upper shaft connecting hole 122, and the other end of the second locking/unlocking member 42 passes through and projects from another hollow guide rod 112.

In an embodiment, the synchronously linkable hand tool of the disclosure further includes an idle gear set 50 which includes a first idle gear 51 and a second idle gear 52. The first idle gear 51 is arranged between the driving gear 21 and the first driven gear 31, and is pivotally connected between the lower casing 11 and the upper casing 12 of the base 10 through the lower rod connecting hole 113 and the upper rod connecting hole 123. The first idle gear 51 is a spur gear which is engaged with the driving gear 21 and the first driven gear 31. The second idle gear 52 is arranged between the driving gear 21 and the second driven gear 41, and is pivotally connected between the lower casing 11 and the upper casing 12 of the base 10 through the lower rod connecting hole 113 and the upper rod connecting hole 123. The second idle gear 52 is a spur gear which is engaged with the driving gear 21 and the second driven gear 41. As a result, the rotational directions of the first locking/unlocking member 32 and the second locking/unlocking member 42 are the same as that of the knob 23.

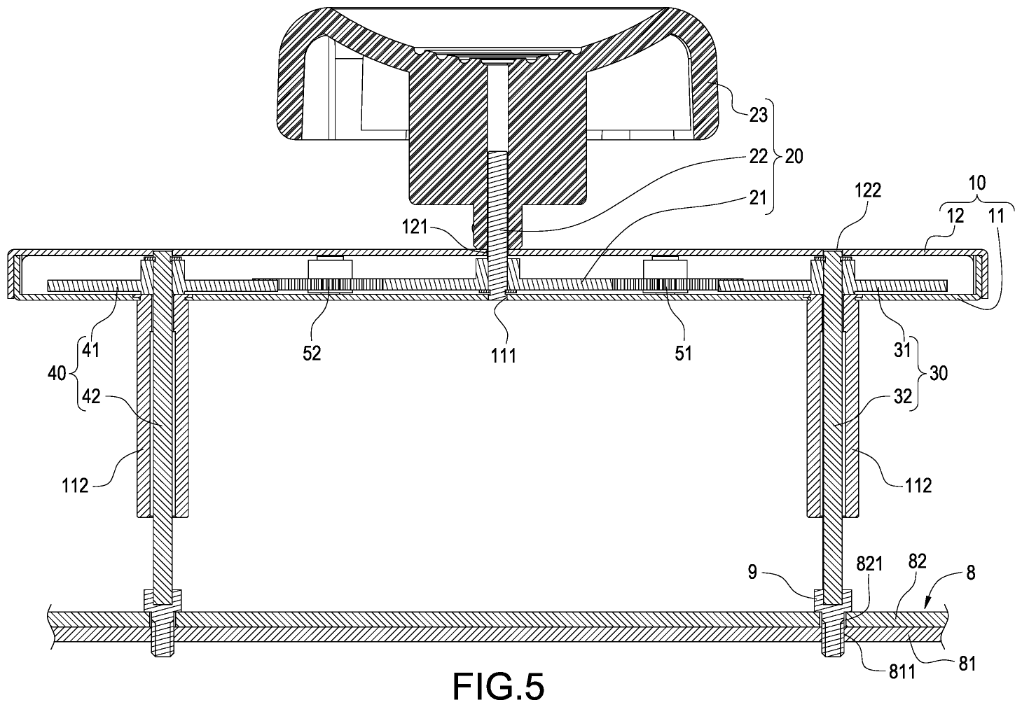

Please refer to FIG. 5. The synchronously linkable hand tool of the disclosure may be applied to a workpiece 8. The workpiece 8 includes a lower plate 81 and an upper plate 82. The lower plate 81 is formed with two threaded holes 811. The upper plate 82 is formed with two passing holes 821 corresponding to the threaded holes 811. When using, two fasteners 9 are correspondingly inserted into the passing holes 821, the first locking/unlocking member 32 and the second locking/unlocking member 42 are embedded into the head portions of the fasteners 9, then, after rotating the knob 23, the first idle gear 51 and the second idle gear 52 are rotated by the driving gear 21, and the first idle gear 51 and the second idle gear 52 further rotate the first driven gear 31 and the second driven gear 41, and the first driven gear 31 and the second driven gear 41 further rotate the first locking/unlocking member 32 and the second locking/unlocking member 42 so as to make the first locking/unlocking member 32 and the second locking/unlocking member 42 be able to synchronously lock or unlock the fasteners 9.

While this disclosure has been described by means of specific embodiments, numerous modifications and variations could be made thereto by those skilled in the art without departing from the scope and spirit of this disclosure set forth in the claims.

What is claimed is:

1. A hand tool comprising:
a base;
a rotation mechanism, rotatably connected to the base, and comprising a driving gear;
a first driven mechanism, disposed on the base, and comprising a first driven gear and a first locking/unlocking member connected to and rotated by the first driven gear;
a second driven mechanism, disposed on the base, and comprising a second driven gear and a second locking/unlocking member connected to and rotated by the second driven gear;
wherein the first driven gear and the second driven gear are rotated by the driving gear to synchronously rotate the first locking/unlocking member and the second locking/unlocking member.

2. The hand tool of claim 1, further comprising an idle gear set disposed between the rotation mechanism, the first driven mechanism and the second driven mechanism.

3. The hand tool of claim 2, wherein the idle gear set comprises a first idle gear and a second idle gear, the first idle gear is arranged between the driving gear and the first driven gear, and the second idle gear is arranged between the driving gear and the second driven gear.

4. The hand tool of claim 3, wherein the rotation mechanism further comprises a shaft and a knob, the shaft passes through and is fixedly connected with the driving gear, and the knob is connected to an end of the shaft away from the driving gear.

5. The hand tool of claim 4, wherein rotational direction of the knob is same as rotational directions of the first locking/unlocking member and the second locking/unlocking member.

6. The hand tool of claim 1, wherein the first locking/unlocking member comprises a flathead screwdriver, a Phillips screwdriver, or a hexagonal screwdriver.

7. The hand tool of claim 1, wherein the second locking/unlocking member comprises a flathead screwdriver, a Phillips screwdriver, or a hexagonal screwdriver.

8. The hand tool of claim 1, wherein the base comprises a lower casing, the lower casing is connected with two hollow guide rods, and the first locking/unlocking member and the second locking/unlocking member separately pass through and project from each hollow guide rod.

9. The hand tool of claim 8, wherein the base comprises an upper casing corresponding to the lower casing, the upper casing comprises a through hole, the lower casing comprises a pivot hole corresponding to the through hole, the rotation mechanism further comprises a shaft, and the shaft passes through the through hole, the driving gear, and the pivot hole in order.

10. The hand tool of claim 8, wherein the upper casing comprises two upper shaft connecting holes, each upper shaft connecting hole is arranged corresponding to each hollow guide rod, and an end of the first locking/unlocking member and an end of the second locking/unlocking member are pivotally disposed in the upper shaft connecting holes respectively.
